(19) United States
(12) Patent Application Publication
(10) Pub. No.: US 2026/0106959 A1
(43) Pub. Date: Apr. 16, 2026

(54) CAMERA SYSTEM FOR A VEHICLE, USE OF A CAMERA SYSTEM AND VEHICLE

(71) Applicant: Robert Bosch GmbH, Stuttgart (DE)

(72) Inventor: Wolfgang Niehsen, Bad Salzdetfurth (DE)

(21) Appl. No.: 19/346,884

(22) Filed: Oct. 1, 2025

(30) Foreign Application Priority Data
Oct. 11, 2024 (DE) 10 2024 209 908.2

(51) Int. Cl. H04N 13/243; H04N 23/90

(52) U.S. Cl. CPC H04N 13/243; H04N 23/90

(57) ABSTRACT

A camera system for three-dimensional object detection for a vehicle having a front and/or rear windshield. The camera system includes at least two, preferably four cameras that are arranged on the inside of the front or rear windshield of the vehicle, wherein the front or rear windshield includes an edge region on both sides and in each case at least one camera is arranged in the two edge regions. A use of the camera system and a vehicle are also described.

### CROSS REFERENCE

The present application claims the benefit under 35 U.S.C. § 119 of Germany Patent Application No. DE 10 2024 209 908.2 filed on Oct. 11, 2024, which is expressly incorporated herein by reference in its entirety.

### FIELD

The present invention relates to a camera system for a vehicle. It also relates to a use of the camera system and to a vehicle having a camera system according to the present invention.

### BACKGROUND INFORMATION

Driver assistance systems and autonomous driving systems in vehicles comprise optical systems, typically camera systems, whose recorded data are digitally processed. Of particular importance in digital processing is computer-aided object recognition, which is used to identify other vehicles, pedestrians, and much more in a recorded camera image. The design of the camera systems used for this purpose is a compromise between various conflicting design objectives, including the largest possible field of view (FoV), the widest possible working range and/or spectral range, sensitivity, temporal resolution, etc.

In the field of these camera systems, stereo camera systems, i.e. systems having two or more cameras, play an important role, in particular in safety-critical tasks, such as automated emergency braking. The main advantage of stereo camera systems compared to monocular camera systems is the possibility of three-dimensional object detection and scene tracking. This provides the possibility of direct three-dimensional measurements using fundamental geometric relationships, such as those that can be used in a—duly calibrated—stereo camera system.

However, due to the large space requirements and high cost of such a camera system, along with the very high demands on the quality of calibration of the various cameras, such systems have not yet come into widespread use. At the same time, however, there are currently no suitable alternatives that meet the complex requirements of the safety-relevant areas of autonomous driving.

The main problem with the use of stereo camera systems in the field of autonomous driving is the limited distance at which three-dimensional object detection and scene tracking is possible. For a typical stereo camera system with a resolution of 1.2 megapixels, a 50° horizontal field of view and a camera separation of approximately 12 cm, this distance is approximately 55 meters.

The present invention is concerned with the task of providing a camera system that increases the distance for reliable three-dimensional object detection and scene tracking. In order to achieve the object, a camera system having certain features is provided according to the present invention. Preferred embodiments of the present invention can be found in the disclosure herein. Furthermore, a use of a camera system according to the present invention and a vehicle are provided according to the present invention.

### SUMMARY

The present invention provides a camera system for three-dimensional object detection for a vehicle having a front and/or rear windshield. According to an example embodiment of the present invention, the camera system comprises at least two, preferably four cameras that are arranged on the inside of the front or rear windshield of the vehicle, wherein the front or rear windshield comprises an edge region on both sides and in each case at least one camera is arranged in the two edge regions. This arrangement ensures that the cameras are as far apart as possible, which makes it possible to detect parallactic shifts of objects in space at greater distances. In this way, three-dimensional object detection and three-dimensional scene tracking via camera over long distances are possible. Preferably, four cameras are used, wherein the cameras are arranged in pairs in the left and right edge regions of the front or rear windshield. Preferably, in the left and right edge regions (viewed in the forward driving direction of the vehicle) of the front or rear windshield, one camera is arranged in an upper area of the windshield and one camera in a lower area of the windshield. In this case, six independent parallactic measurement options—namely all possible camera combinations in pairs—are available. The edge regions are preferably bounded on one side by the edge of the front or rear windshield that is cut off by a body element.

It is further provided that the cameras are in each case arranged in an overlap region of the particular edge region having a cleaning region (R) of at least one windshield wiper. This preferred embodiment of the present invention ensures that the field of view of the cameras is not restricted by rain. The field of view of the cameras also benefits from the cleaning mechanisms usually provided for the front or rear windshield, which cleaning mechanisms are typically implemented via a windshield wiper system.

It is further provided according to an example embodiment of the present invention that each camera be mounted on a separate holding device. This preferred embodiment of the present invention, in comparison with the use of a common, rigid holding device, as typically employed to preserve the sensitive camera calibration, makes possible a more widely spaced camera arrangement, by which parallactic shifts are perceived at greater distances and, accordingly, three-dimensional object detection and scene tracking are possible over greater distances.

Not using a common, rigid holding device has a negative impact on camera calibration. In particular, everyday thermal and mechanical forces lead to small shifts of the cameras relative to one another, making it impossible to reliably maintain a calibration once performed. It is therefore provided according to an example embodiment of the present invention that the camera system comprises a computing unit that is configured to execute a dedicated hardware algorithm for feature assignment. In this preferred embodiment of the present invention, the compensating effect, which is usually pursued by means of calibration, is calculated based on individual images. The algorithm superimposes contours and object edges that are recognized as identical on individual images in order to generate the reference points required for parallactic measurement. The term “dedicated hardware algorithm for feature assignment” describes a specialized algorithm that is executed on hardware-optimized computer architectures in order to efficiently and in real time recognize and match features between image data.

According to an example embodiment of the present invention, it is also provided that at least one camera exhibits a horizontal field of view of 15°. In pursuing the goal of making possible three-dimensional object detection and scene tracking over long distances, greater sharpness at long distances is physically achieved at the expense of close-range resolution. A horizontal field of view of 15° provides the highest possible resolution at long range while simultaneously covering a medium distance range equivalent to approximately three highway lanes, which is sufficient for typical applications in the field of vehicle sensing.

According to an example embodiment of the present invention, it is further provided that at least one camera comprises a telephoto lens and an image sensor having a resolution of at least two megapixels. The use of a telephoto lens increases the distance at which objects can be resolved and recognized and tracked in three-dimensional object detection. The same applies to the use of an image sensor having sufficient resolution. For an exemplary camera arrangement having a distance between the cameras of 1.3 meters, a horizontal field of view of 15°, an image aspect ratio of 16:9, a pixel pitch of 2.1 micrometers and an f-number of 1.6, the theoretical maximum distance of effective three-dimensional object detection and scene tracking for different resolutions of the image sensor is listed below. The resolution is given in megapixels, the focal length f in pixels, along with the theoretical distance d in meters.

| Resolution [MP] | Pixels per row | f[px] | d [m] |
|---|---|---|---|
| 2.0 | 1920 | 7292 | 97.4 |
| 4.0 | 2715 | 10311 | 115.8 |
| 8.0 | 3840 | 14584 | 137.7 |
| 16.0 | 5430 | 20625 | 163.7 |

In practice, the listed distances can only be achieved if measures are taken to stabilize the image and compensate for motion blur.

In a further development of the present invention, it is provided that at least one camera comprises a controllable lens and/or a controllable image sensor. This preferred embodiment of the present invention has a stabilizing effect on the resulting image in the case of a moving scene and/or a camera movement. In this way, sufficiently sharp imaging can be achieved even at long distances, allowing the results to be used for three-dimensional object detection and scene tracking. A controllable lens or a controllable image sensor is a lens or an image sensor that, in order to be able to perform compensatory movements, is equipped with an electromechanical system which is controllable in a closed-loop manner.

It is also suggested that at least one camera is mounted in a cardanic manner. Due to this preferred embodiment of the present invention, the images recorded by the individual cameras of the camera system are stabilized, which reduces motion blur occurring when the camera system and/or the scene is moving and thereby improves object tracking and three-dimensional scene detection at long distances, even at low ambient brightness (and thus with a necessarily longer exposure time).

According to an example embodiment of the present invention, it is further provided that the cardanic mounting is designed as a gimbal, wherein the gimbal comprises at least one servo motor for performing a rotational movement about a roll axis and a tilt axis. In this preferred embodiment, camera movements and/or scene movements can be actively compensated for, which in turn results in reduced motion blur at longer possible exposure times and thus in images having more robust object recognition. This in turn strengthens three-dimensional object detection and scene tracking. A gimbal is a mechanically motorized arm pivotably mounted about at least two axes, which is suitable for compensating the movements of an optical device.

According to an example embodiment of the present invention, it is further provided that the gimbal comprises an inertial measuring unit for measuring a spatial acceleration. With the inertial measuring unit, which is preferably arranged on the camera, a movement of the camera system and/or of the camera can be measured. On the basis of these measurement data, a compensating movement can be determined for any occurring movement and can be performed by means of the servo motors, whereby the image is stabilized.

In addition, according to an example embodiment of the present invention, it is provided that the gimbal be controllable via a closed control loop. With this preferred embodiment, motion blur is significantly reduced when the camera system and/or scene are moving. In particular, when using a closed control loop, a specific maximum tolerated movement, motion blur or a desired exposure time with a specified motion blur can be set. This improves image stability, reduces motion blur and makes sharper images at greater distances possible.

Moreover, according to an example embodiment of the present invention, it is provided that an intersection point of the roll axis and the tilt axis is coincident with a perspective center of the camera. This preferred embodiment has the result that any rotational movement of the camera caused by the motorized arm is in the image plane, thus avoiding parallactic shift effects.

According to an example embodiment of the present, it is further proposed that the gimbal further comprises at least one servo motor for performing a rotational movement about a yaw axis, wherein the yaw axis intersects the intersection point of the roll and tilt axes. Adding the yaw axis makes movement compensation in a third spatial dimension possible. In this way, the image can be fully stabilized with respect to any spatial direction of movement.

In a further development of the present invention, it is provided that the gimbal has an active controller by means of which the camera can be rotated beyond a movement compensation of the camera system and/or of the camera. In this preferred embodiment, an artificial enlargement of the field of view is made possible by the camera being actively rotated about an axis while sequentially capturing a wide scene. Preferably, such rotation takes place about a yaw axis.

The use of a camera system according to the present invention as a data source for a driver assistance system and/or a system for autonomous driving is also proposed. Such use provides the aforementioned advantages to the driver assistance system and/or the system for autonomous driving.

Furthermore, a vehicle is provided, comprising a camera system according to the present invention. Such a vehicle comprises the aforementioned advantages.

The present invention is explained in more detail below with reference to the figures.

### BRIEF DESCRIPTION OF THE DRAWINGS

FIG. 1 is a schematic representation of a camera system according to an example embodiment of the present invention.

FIG. 2 is a schematic representation of a camera of a camera system according to an example embodiment of the present invention.

### DETAILED DESCRIPTION OF EXAMPLE EMBODIMENTS

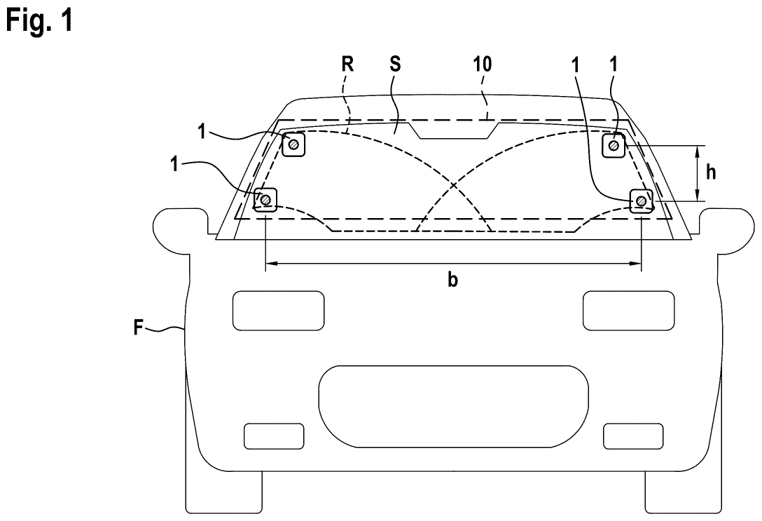

FIG. 1 shows a camera system 10 according to the present invention comprising four cameras 1. In the present example, these are arranged on the inside of a front windshield S of a vehicle F. The front windshield S comprises a left and a right edge region in which the cameras 1 is arranged in each case. The cameras 1 are positioned so that they are within the cleaning region R of the vehicle windshield wipers. The greatest spacing of the cameras 1 is marked by the width b, and the vertical spacing of the cameras 1 by the height h. The greater the width b and the height h, the greater the distance at which three-dimensional object detection and scene tracking is reliably possible. The configuration shown provides six independent parallactic measurement options by comparing the images of respective pairs of cameras: driver-side lower and passenger-side lower, driver-side lower and passenger-side upper, driver-side upper and passenger-side lower, driver-side upper and passenger-side upper, driver-side upper and lower, and passenger-side upper and lower.

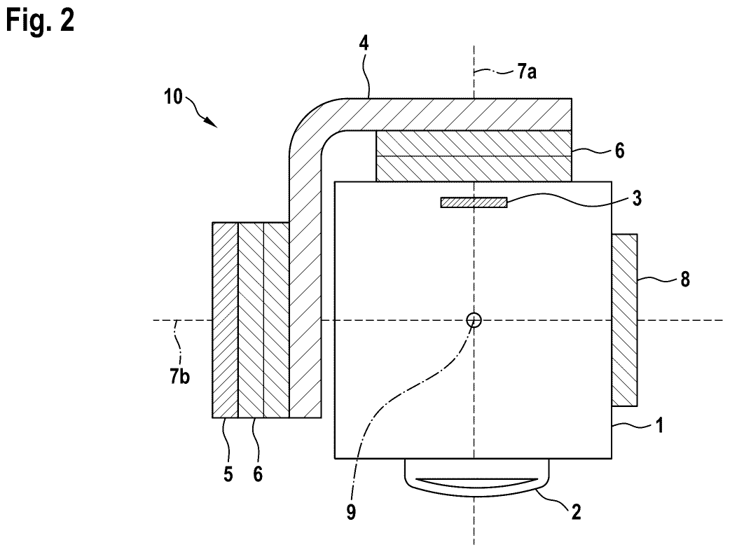

FIG. 2 shows a camera 1 of a camera system 10 according to the present invention. The camera 1, comprising a telephoto lens 2 and an image sensor 3, is mounted on a gimbal 4. The gimbal 4 comprises two servo motors 6 for transmitting rotational movements to the camera 1 on two axes (7a, 7b). One servo motor 6 is designed for performing a rotational movement about a roll axis 7a of the camera 1, the second servo motor is designed for performing a rotational movement about a tilt axis 7b of the camera 1. The intersection point of the roll axis 7a and the tilt axis 7b is coincident with the perspective center 9 of the camera 1. Furthermore, the camera 1 has an inertial measuring unit 8. The motorized arm 4 also has a base 5 for mounting on an external bracket. When the camera system 10 and/or the camera 1 is moved, the inertial measuring unit 8 records the direction and magnitude of the movement. On the basis of the measurement, the servo motors 6 initiate corresponding compensating rotational movements about the roll axis 7a and the tilt axis 7b in order to keep the image stable despite movement.

What is claimed is:

1. A camera system for three-dimensional object detection for a vehicle having a front and/or rear windshield, the camera system comprising:
at least two cameras that are arranged on an inside of the front windshield or the rear windshield of the vehicle, wherein the front windshield or the rear windshield includes an edge region on both sides and at least one of the at least two cameras is arranged in each of the edge regions.

2. The camera system according to claim 1, wherein the at least two cameras include four cameras.

3. The camera system according to claim 1, wherein each of the cameras is each arranged in an overlap region of the edge region in which the camera is arranged, the overlap region a cleaning region of at least one windshield wiper.

4. The camera system according to claim 1, wherein each of the cameras is mounted on a separate holding device.

5. The camera system according to claim 1, wherein the camera system includes a computing unit that is configured to execute a dedicated hardware algorithm for feature assignment.

6. The camera system according to claim 1, wherein at least one of the cameras exhibits a horizontal field of view of 15°.

7. The camera system according to claim 1, wherein at least one of the cameras includes a telephoto lens and an image sensor having a resolution of at least two megapixels.

8. The camera system according to claim 1, wherein at least one of the cameras includes a controllable lens and/or a controllable image sensor.

9. The camera system according to claim 1, wherein at least one of the cameras is mounted in a cardanic manner.

10. The camera system according to claim 9, wherein the cardanic mounting is a gimbal, wherein the gimbal includes at least one servo motor for performing a rotational movement about a roll axis and a tilt axis.

11. The camera system according to claim 10, wherein the gimbal includes an inertial measuring unit for measuring a spatial acceleration.

12. The camera system according to claim 10, wherein the gimbal can be controlled via a closed control loop.

13. The camera system according to claim 10, wherein an intersection point of the roll axis and the tilt axis is coincident with a perspective center of the at least one camera.

14. The camera system according to claim 10, wherein the gimbal further includes at least one servo motor for performing a rotational movement about a yaw axis, wherein the yaw axis intersects the intersection point of the roll and tilt axes.

15. The camera system according to claim 10, wherein the gimbal has an active controller using which the at least one camera can be rotated beyond a movement compensation of the camera system and/or of the at least one camera.

16. A method of using a camera system, the method comprising:
providing a camera system for three-dimensional object detection for a vehicle having a front and/or rear windshield, the camera system including:
at least two cameras that are arranged on an inside of the front windshield or the rear windshield of the vehicle, wherein the front windshield or the rear windshield includes an edge region on both sides and at least one of the at least two cameras is arranged in each of the edge regions; and
using the camera system as a data source for a driver assistance system and/or a system for autonomous driving.

17. A vehicle, comprising:
a front windshield and/or a rear windshield; and
a camera system for three-dimensional object detection, the camera system including:
at least two cameras that are arranged on an inside of the front windshield or the rear windshield of the vehicle, wherein the front windshield or the rear windshield includes an edge region on both sides and at least one of the at least two cameras is arranged in each of the edge regions.
